(19) United States
(12) Patent Application Publication
(10) Pub. No.: US 2026/0141122 A1
(43) Pub. Date: May 21, 2026

(54) CONNECTION DEVICE, CONNECTION METHOD, AND RECORDING MEDIUM

(71) Applicant: NEC Corporation, Minato-ku, Tokyo (JP)

(72) Inventor: Kenji TAKEZAWA, Tokyo (JP)

(73) Assignee: NEC Corporation, Minato-ku, Tokyo (JP)

(21) Appl. No.: 18/697,518

(22) PCT Filed: Oct. 27, 2022
(86) PCT No.: PCT/JP2022/040213

§ 371 Date: Apr. 1, 2024

(30) Foreign Application Priority Data
Nov. 30, 2021 (JP) 2021-193710

(51) Int. Cl. G06F 21/71; G06F 21/60

(52) U.S. Cl. CPC G06F 21/71; G06F 21/602

(57) ABSTRACT

In order to enable to reduce the occurrence of tamper or leak of data held by a host computer when a device that should not be originally connected is connected to the host computer, a connection device for connecting a host device and a target device that is a device to be connected to the host device includes a reading unit that reads device information, which is information capable of identifying a device, from the target device, and a connecting unit that connects the target device and the host device in a case where the device information read from the target device exists in an allowed list that is a list of the device information of a device connectable to the host device.

### TECHNICAL FIELD

The present invention relates to a connection device and the like.

### BACKGROUND ART

When an IO (Input Output) device is connected to a host computer, a system administrator generally confirms whether the IO device may be connected to the host computer. The system administrator visually checks whether the IO device is an IO device of which connection is prohibited or an IO device of which connection cannot be permitted due to compatibility or vulnerability so as to determine whether the IO device can be connected.

However, as in an IO distribution system in which IO devices are connected to a host computer via a network, there is a case where a physical distance between the IO devices and the host computer is separated. As described above, when the IO device and the host computer are separated from each other, the system administrator near the host computer cannot visually confirm the IO device. The IO distribution system is constructed by, for example, ExpEther. ExpEther is a technology for transmitting various signals used in industrial equipment by Ethernet (registered trademark) or wirelessly with high reliability and low delay.

Meanwhile, peripheral component interconnect (PCI)-Express is a standard for connecting a central processing unit (CPU) and an IO device. The PCI-Express is also referred to as PCIe. In a case where the IO device is compatible with PCIe, an operating system (OS) operating on the host computer automatically performs negotiation when recognizing that the IO device is connected. Then, the IO device is connected to the host computer. Negotiation is performed to incorporate the IO device into the computer system.

As described above, when the IO device is compatible with PCIe, the host computer automatically performs negotiation. Therefore, in a case where it is determined whether the IO device can be connected by a method other than visual observation, generally, software operating on the host computer determines whether the IO device can be connected.

As a related technique, there is a technique described in PTL 1.

### CITATION LIST

### Patent Literature

PTL 1: JP 2007-200212 A

### SUMMARY OF INVENTION

### Technical Problem

However, in the method in which the software operating on the host computer determines whether to connect, there is a possibility that tamper or leak of data held by the host computer occurs. In this method, software running on a host computer determines whether connection is possible. Therefore, in a case where the software of the host computer is tampered by a malicious person, there is a possibility that an IO device that should not be originally connected is connected to the host computer. As a result, there is a possibility that data held by the host computer is tampered or leaked via the IO device.

An object of the present invention is to provide a connection device and the like that which can reduce occurrence of tamper or leak of data held in a host computer when a device that should not be originally connected is connected to the host computer.

### Solution to Problem

According to one aspect of the present invention, a connection device for connecting a host device and a target device that is a device to be connected to the host device, includes: a reading means for reading device information, which is information capable of identifying a device, from the target device; and a connecting means for connecting the target device and the host device in a case where the device information read from the target device exists in an allowed list that is a list of the device information of a device connectable to the host device.

According to another aspect of the present invention, a connection method of a connection device for connecting a host device and a target device that is a device to be connected to the host device, includes: reading device information, which is information capable of identifying a device, from the target device; and connecting the target device and the host device in a case where the device information read from the target device exists in an allowed list that is a list of the device information of a device connectable to the host device.

In another aspect of the present invention, a connection program recorded in a computer-readable recording medium is a connection program for a connection device that connects a host device and a target device that is a device to be connected to the host device, the connection program causing a computer to execute: a reading function of reading device information, which is information capable of identifying a device, from the target device; and a connection function of connecting the target device and the host device in a case where the device information read from the target device exists in an allowed list that is a list of the device information of a device connectable to the host device.

### Advantageous Effects of Invention

According to the present invention, it is possible to reduce the occurrence of tamper or leak of data held by a host computer when a device that should not be originally connected is connected to the host computer.

### BRIEF DESCRIPTION OF DRAWINGS

FIG. 1 is a diagram illustrating a configuration example of a connection device according to a first example embodiment of the present invention.

FIG. 2 is a diagram illustrating an example of an operation flow of the connection device according to the first example embodiment of the present invention.

FIG. 3 is a diagram illustrating a connection example related to a connection device according to a second example embodiment of the present invention.

FIG. 4 is a diagram illustrating a configuration example of the connection device according to the second example embodiment of the present invention.

FIG. 5 is a diagram illustrating an example of an operation flow of the connection device according to the second example embodiment of the present invention.

FIG. 6 is a diagram illustrating an example of an operation flow of the connection device according to the second example embodiment of the present invention.

FIG. 7 is a diagram illustrating a hardware configuration example of each example embodiment of the present invention.

### EXAMPLE EMBODIMENT

### First Example Embodiment

A first example embodiment of the present invention is described. A specific example of a connection device 10 in the first example embodiment is a connection device 20 in a second example embodiment described later.

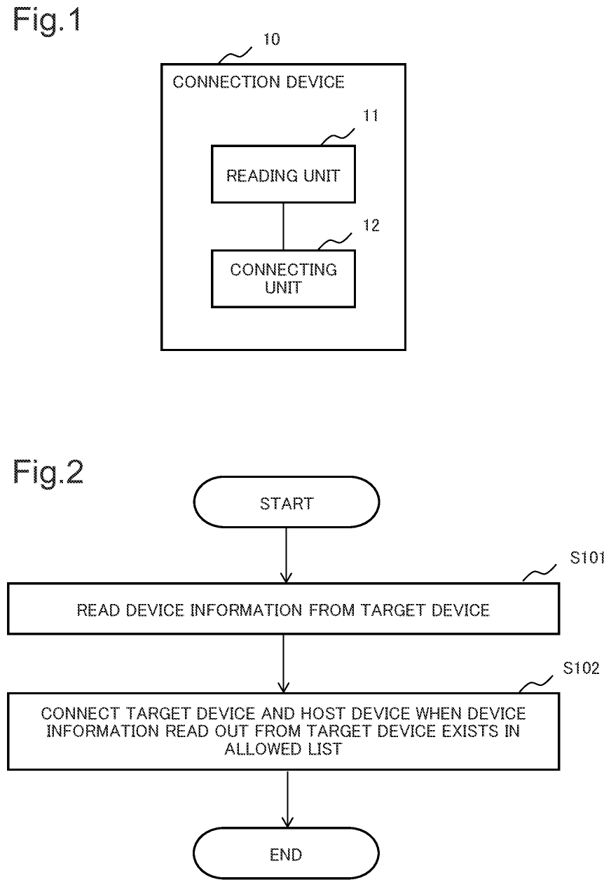

FIG. 1 illustrates a configuration example of the connection device 10 according to the present example embodiment. The connection device 10 of the present example embodiment includes a reading unit 11 and a connecting unit 12.

The reading unit 11 reads device information, which is information that can identify a device, from a target device that is a device to be connected. The connecting unit 12 connects the target device and the host device in a case where the device information read from the target device exists in an allowed list that is a list of the device information of the device connectable to the host device.

Next, FIG. 2 illustrates an example of an operation flow of the connection device 10 according to the present example embodiment.

The reading unit 11 reads device information, which is information that can identify a device, from a target device which is a device to be connected (step S101). The connecting unit 12 connects the target device and the host device in a case where the device information read from the target device exists in the allowed list that is a list of the device information of the device connectable to the host device (step S102).

As described above, in the first example embodiment of the present invention, the connection device 10 includes the reading unit 11 and the connecting unit 12. The reading unit 11 reads the device information from the target device. The connecting unit 12 connects the target device and the host device in a case where the device information read from the target device exists in an allowed list that is a list of the device information of the device connectable to the host device. As a result, instead of the host device, the connection device 10 determines whether the target device can be connected to the host device. As a result, even in a case where the software of a host device 50 is tampered, the logic for determining availability of connection is not tampered. Therefore, it is possible to reduce connection of a device that should not be originally connected to the host device. Therefore, it is possible to reduce tamper or leak of data held by the host device 50 due to connection of a device that should not be originally connected to the host device 50.

### Second Example Embodiment

Next, a connection device 20 according to a second example embodiment of the present invention is described.

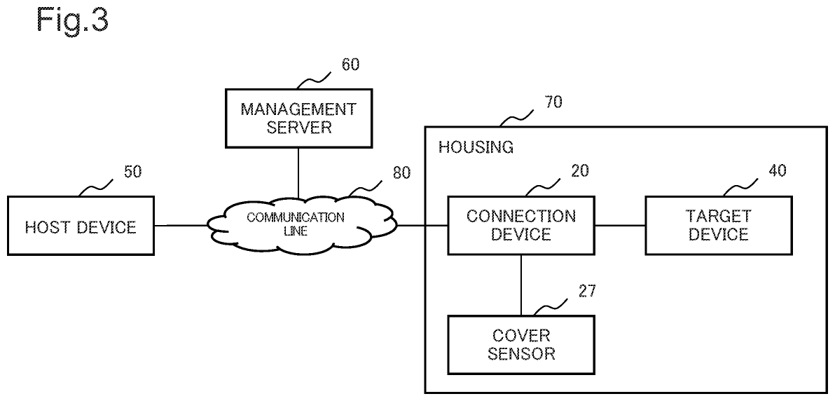

First, FIG. 3 illustrates a connection example regarding the connection device 20 of the present example embodiment. A target device 40 is connected to the connection device 20. The connection device 20, the host device 50, and a management server 60 are connected to each other via a communication line 80. A cover sensor 27 is connected to the connection device 20.

The connection device 20 of the present example embodiment is assumed to be applied to an IO distribution system. Therefore, the target device 40 and the host device 50 are installed in a place where a physical distance is long.

The connection device 20 connects the target device 40 and the host device 50 via the communication line 80. The communication line 80 is, for example, the Internet or a local network by a dedicated line.

The target device 40 is, for example, an IO device. The IO device provides data input/output to the host device 50.

The host device 50 is a connection destination device of the target device 40, and is, for example, an information processing device.

The management server 60 has an allowed list. The allowed list is a list of device information of a device connectable to the host device 50. The device information is information that can identify the device. The device information includes, for example, a model number, a serial number, a vendor identification (ID), a device ID, and the like of the device.

A housing 70 accommodates the connection device 20. The target device 40 is installed inside the housing 70. The cover sensor 27 is provided on the cover of the housing 70.

The cover sensor 27 is a sensor that detects opening and closing of the cover of the housing 70. In a case where the cover of the housing 70 has been opened, the cover sensor 27 outputs a signal indicating that the cover is opened to a detection unit 26. In a case where the cover is closed, the cover sensor 27 may output a signal indicating that the cover is closed to the detection unit 26.

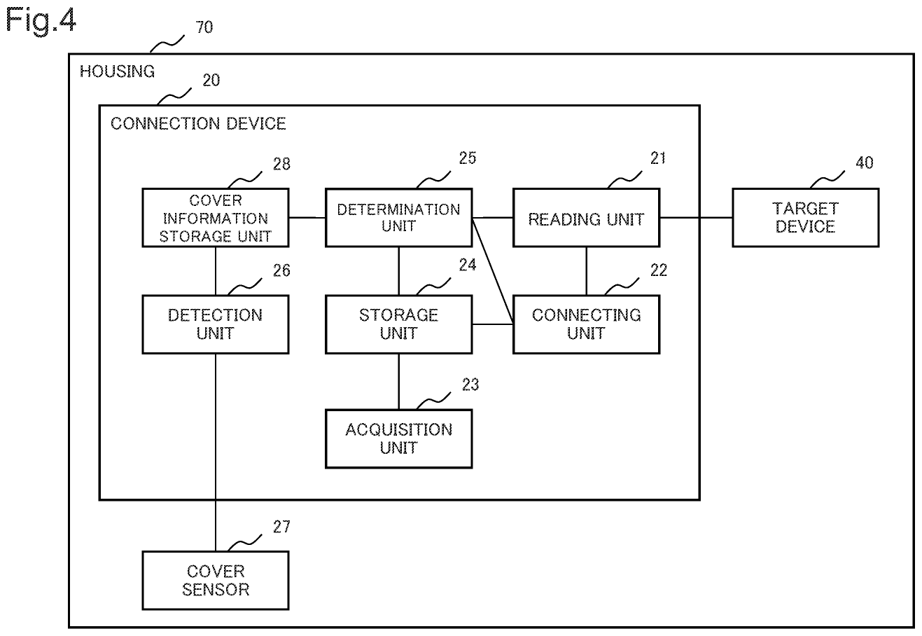

Next, FIG. 4 illustrates a configuration example of the connection device 20 according to the present example embodiment. The connection device 20 of the present example embodiment includes a reading unit 21, a connecting unit 22, an acquisition unit 23, a storage unit 24, a determination unit 25, a detection unit 26, and a cover information storage unit 28.

The storage unit 24 stores an allowed list, a certificate, a group ID, connection device information, and device information. The storage unit 24 stores the certificate, the group ID, and the connection device information in advance. The allowed list is stored in the storage unit 24 by the acquisition unit 23. The device information is stored in the storage unit 24 by the reading unit 21.

The connection device information is information that can identify the connection device 20. The connection device information includes, for example, a device model number, a serial number, a firmware (FW) hash value, and the like.

The certificate is information indicating that the connection device 20 is a genuine product. The certificate includes connection device information of the connection device 20.

The group ID is information on a group to which the connection device 20 belongs. Each of the host device 50 and the connection device 20 has a group ID, and the host device 50 and the connection device 20 having the same group ID can be connected.

The cover information storage unit 28 stores cover information. The cover information is information regarding opening and closing of the cover of the housing of the connection device 20. The cover information is stored in the storage unit 24 by the detection unit 26.

The detection unit 26 stores the cover information in the cover information storage unit 28 based on the signal output from the cover sensor 27. More specifically, when receiving a signal indicating that the cover has been opened from the cover sensor 27, the detection unit 26 stores information indicating that the cover has been opened in the cover information storage unit 28. The detection unit 26 clears the cover information to a state indicating that the cover is not opened at a predetermined timing, for example, when the power of the connection device 20 is turned off or when an instruction is input from an administrator terminal (not illustrated). In this way, the detection unit 26 can cause the cover information storage unit 28 to store the cover information indicating whether the cover has been opened before the cover information is cleared.

The detection unit 26, the cover sensor 27, and the cover information storage unit 28 are supplied with power in a different system from the power supply to the connection device 20. Even in a case where power is not supplied to the other part of the connection device 20, power is supplied to the detection unit 26, the cover sensor 27, and the cover information storage unit 28. Therefore, the detection unit 26 can store the cover information in the cover information storage unit 28 before turning on the power to the connection device 20.

The determination unit 25 determines validity of the connection device 20. When power is supplied to the connection device 20, the determination unit 25 reads the connection device information stored in the storage unit 24. The determination unit 25 reads the certificate stored in the storage unit 24 and extracts the connection device information from the read certificate. Then, when the connection device information stored in the storage unit 24 matches the connection device information extracted from the certificate, the determination unit 25 determines that the connection device 20 is valid. In a case where the information does not match, there is a possibility that some unauthorized tamper has been performed on the connection device 20, and thus the administrator terminal is notified that the information does not match.

The determination unit 25 determines whether the cover has been opened based on the cover information stored in the cover information storage unit 28. In a case where the cover information indicates that the cover has been opened, the determination unit 25 notifies the administrator terminal that the cover has been opened.

The reading unit 21, the connecting unit 22, and the acquisition unit 23 operate when an operating condition is satisfied. The operating condition is to satisfy the following conditions (1) and (2).
(1) The determination unit 25 determines that the connection device 20 is valid.
(2) The determination unit 25 determines that the cover is not opened.

The determination unit 25 may not perform any one or both of the determination of the validity (validity determination) of the connection device 20 and the determination of opening and closing of the cover (cover determination). When the validity determination is not performed, the operating condition satisfies (2). When the cover determination is not performed, the operating condition satisfies (1). When neither the validity determination nor the cover determination is performed, the operating condition is always satisfied.

The connection device 20 may further have a function of measuring the position of the connection device 20, and may detect that the connection device 20 has moved from the original installation place. In this case, the condition (2) may be a condition that the determination unit 25 determines that the cover is not opened and the connection device 20 is not moved. The connection device 20 can measure the position using, for example, a global navigation satellite system (GNSS), a beacon, or the like.

When the operating condition is satisfied, the acquisition unit 23 acquires the allowed list from the management server 60 and stores the acquired allowed list in the storage unit 24. More specifically, the acquisition unit 23 first transmits the certificate stored in the storage unit 24 to the management server 60. When the management server 60 confirms that the connection device 20 is a genuine product based on the certificate, the acquisition unit 23 receives the allowed list from the management server 60. When the connection device information registered in the management server 60 matches the connection device information included in the certificate received from the connection device 20, the management server 60 determines that the connection device 20 is a genuine product.

When the target device 40, which is a device to be connected, is connected to the connection device 20, the reading unit 21 reads the device information from the target device 40. The reading unit 21 stores the device information read from the target device 40 in the storage unit 24. The reading unit 21 operates when the operating condition is satisfied.

When the device information read from the target device 40 exists in the allowed list stored in the storage unit 24, the connecting unit 22 connects the target device 40 and the host device 50. When the device information read from the target device 40 does not exist in the allowed list stored in the storage unit 24, the connecting unit 22 does not connect the target device 40 to the host device 50 and notifies the administrator terminal. The reading unit 21 operates when the operating condition is satisfied.

More specifically, when receiving a management packet from the host device 50, the connecting unit 22 transmits the group ID stored in the storage unit 24 to the host device 50. Then, when a connection permission is received from the host device 50, the target device 40 and the host device 50 are connected.

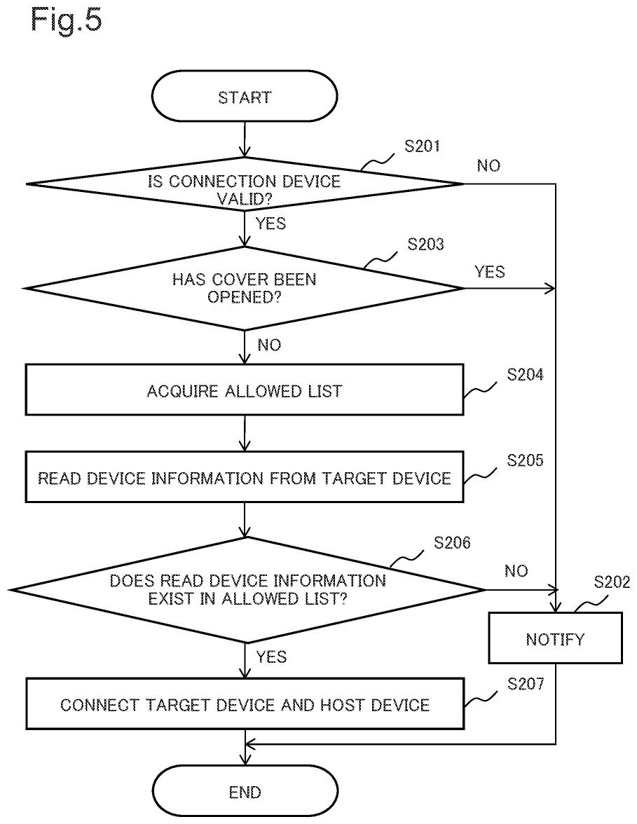

Next, FIG. 5 illustrates an example of an operation flow of the connection device 20 according to the present example embodiment.

First, when power is supplied to the connection device 20, the determination unit 25 confirms the validity of the connection device 20 (step S201).

More specifically, the determination unit 25 reads the connection device information stored in the storage unit 24. The determination unit 25 reads the certificate stored in the storage unit 24 and extracts the connection device information from the read certificate. Then, when the connection device information stored in the storage unit 24 matches the connection device information extracted from the certificate, the determination unit 25 determines that the connection device 20 is valid. In a case where the information does not match (NO in step S201), there is a possibility that some unauthorized tamper has been performed on the connection device 20, and thus, the determination unit 25 notifies the administrator terminal that the information does not match (step S202).

In a case where the connection device 20 is determined to be valid (YES in step S201), the determination unit 25 confirms whether the cover has been opened based on the cover information stored in the cover information storage unit 28. In a case where the cover information indicates that the cover has been opened (YES in step S203), the determination unit 25 notifies the administrator terminal that the cover has been opened (step S202).

The reading unit 21, the connecting unit 22, and the acquisition unit 23 operate when an operating condition is satisfied. The operating condition is to satisfy the following conditions (1) and (2).
(1) The determination unit 25 determines that the connection device 20 is valid (YES in step S201).
(2) The determination unit 25 determines that the cover is not opened (NO in step S203).

When the operating condition is satisfied, the acquisition unit 23 acquires the allowed list from the management server 60 and stores the acquired allowed list in the storage unit 24 (step S204). More specifically, the acquisition unit 23 transmits the certificate stored in the storage unit 24 to the management server 60. When the management server 60 that has received the certificate determines that the connection device is the valid connection device 20, the acquisition unit 23 receives the allowed list from the management server 60. When the connection device information registered in the management server 60 matches the connection device information included in the certificate received from the connection device 20, the management server 60 determines that the connection device is the valid connection device 20.

When the target device 40, which is a device to be connected, is connected to the connection device 20, the reading unit 21 reads the device information from the target device 40. The reading unit 21 stores the device information read from the target device 40 in the storage unit 24 (step S205). The reading unit 21 operates when the operating condition is satisfied.

When the device information read from the target device 40 exists in the allowed list stored in the storage unit 24 (YES in step S206), the connecting unit 22 connects the target device 40 and the host device 50 (step S207). When the device information read from the target device 40 does not exist in the allowed list stored in the storage unit 24 (NO in step S206), the connecting unit 22 does not connect the target device 40 to the host device 50 and notifies the administrator terminal (step S202). The reading unit 21 operates when the operating condition is satisfied.

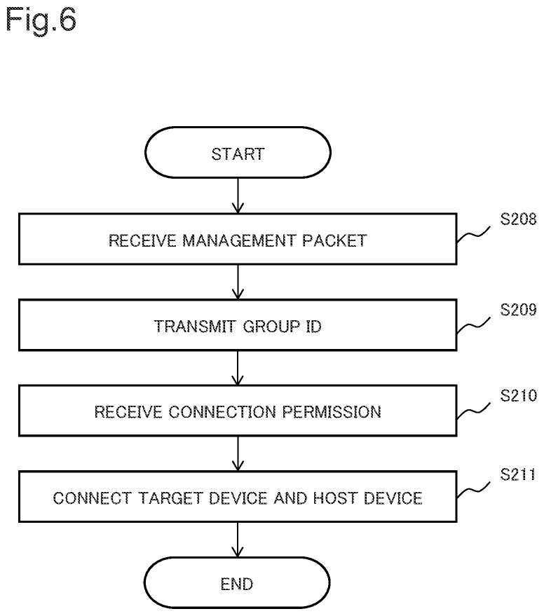

Next, FIG. 6 illustrates an example of a more specific operation flow of the connection device 20 regarding the connection (step S207) between the target device 40 and the host device 50.

The connecting unit 22 waits for reception of a management packet from the host device 50. The host device 50 transmits the management packet to the connection device 20 at a predetermined timing such as when power is supplied. When the management packet is received (step S208), the connecting unit 22 transmits the group ID stored in the storage unit 24 to the host device 50 (step S209). When matching between the group ID stored in the host device 50 and the group ID transmitted from the connection device 20 is confirmed by the host device 50 and connection permission is received from the host device 50 (step S210), the connecting unit 22 connects the target device 40 and the host device 50 (step S211). Then, when the operating system of the host device 50 is activated, the system including the host device 50 and the target device 40 becomes operable.

As described above, in the second example embodiment of the present invention, the connection device 20 includes the reading unit 21 and the connecting unit 22. The reading unit 21 reads the device information from the target device 40. The connecting unit 22 connects the target device 40 and the host device 50 in a case where the device information read from the target device 40 exists in an allowed list that is a list of the device information of the device connectable to the host device 50. As a result, instead of the host device 50, the connection device 20 determines whether the target device 40 can be connected to the host device 50. As a result, even in a case where the software of a host device 50 is tampered, the logic for determining availability of connection is not tampered. Therefore, it is possible to reduce connection of a device that should not be originally connected to the host device 50. Therefore, it is possible to reduce tamper or leak of data held by the host device 50 due to connection of a device that should not be originally connected to the host device 50.

The connection device 20 according to the present example embodiment acquires the allowed list from the management server 60. Therefore, it is possible to reduce the possibility that tamper is made on the allowed list by tamper on the connection device 20. The allowed list can be easily updated as compared with a case where the allowed list is stored in each of the plurality of connection devices.

The connection device 20 according to the present example embodiment transmits a certificate, which is information indicating that the connection device 20 is a genuine product, to the management server 60. The allowed list is transmitted from the management server 60 to the connection device 20 when the management server 60 confirms that the connection device 20 is a genuine product based on the certificate. Therefore, it is possible to reduce the possibility that the allowed list is transmitted to the unauthorized connection device and the allowed list is leaked.

The connection device 20 of the present example embodiment further includes the storage unit 24 that stores connection device information that is information regarding the connection device 20. The certificate that is the information indicating that the connection device 20 is a genuine product includes connection device information that is information on the connection device 20. The acquisition unit 23 connects the target device 40 and the host device 50 when the connection device information included in the certificate matches the connection device information stored in the storage unit 24. Therefore, it is possible to reduce the possibility that an unauthorized connection device is connected to the host device 50 or a device that should not be originally connected is connected to the host device 50.

The connection device 20 of the present example embodiment further includes the detection unit 26 that causes the cover information storage unit 28 to store cover information that is information regarding opening and closing of the cover based on a signal from the cover sensor 27 that detects opening and closing of the cover of the housing. The housing 70 includes the connection device 20. The target device 40 is installed inside the housing 70. In a case where the cover information stored in the cover information storage unit 28 indicates that the cover is not opened, the connecting unit 22 connects the target device 40 and the host device 50. In a case where the cover information indicates that the cover has been opened, the connecting unit 22 does not connect the target device 40 and the host device 50. As a result, it is possible to reduce the possibility that the tampered connection device 20 or the tampered target device 40 is connected to the host device 50 can be reduced.

When the cover information indicates that the cover has been opened, the determination unit 25 of the present example embodiment notifies the administrator terminal that the cover has been opened. As a result, the administrator can know that there is a possibility that the cover is opened when it is not a planned period such as maintenance, and the unauthorized target device 40 has been attached to the connection device 20 or the connection device 20 has been tampered with.

### Hardware Configuration Example

A configuration example of hardware resources that implement the connection device (10, 20) according to each of the above-described example embodiments of the present invention using one information processing device (computer) is described. The connection device may be achieved physically or functionally by using at least two information processing devices. The connection device may be implemented as a dedicated device. Only some functions of the connection device may be implemented by using the information processing device.

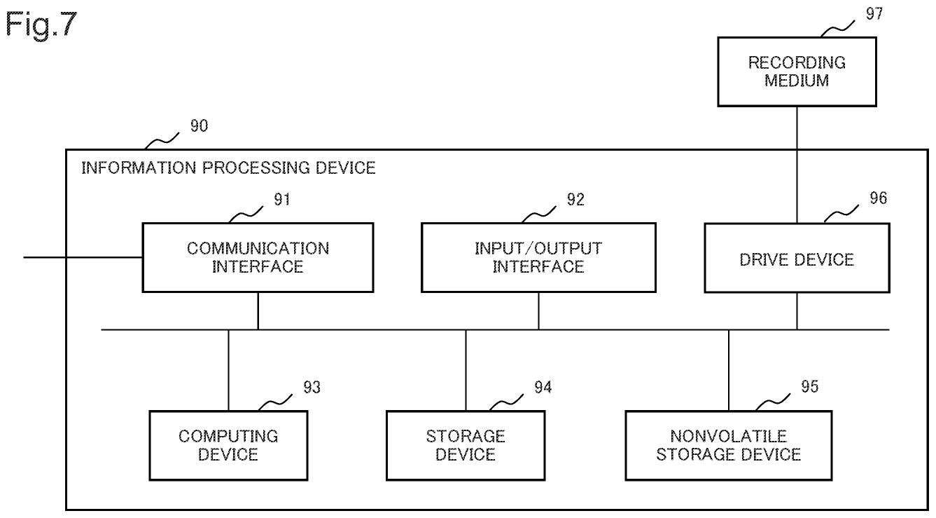

FIG. 7 is a diagram schematically illustrating a hardware configuration example of an information processing device capable of implementing the connection device according to each example embodiment of the present invention. An information processing device 90 includes a communication interface 91, an input/output interface 92, a computing device 93, a storage device 94, a nonvolatile storage device 95, and a drive device 96.

For example, the reading unit 11, the computing device 93, and the connecting unit 12 in FIG. 1 can be implemented by the computing device 93 and the communication interface 91.

The communication interface 91 is a communication means for the connection device of each example embodiment to communicate with an external device in a wired or/and wireless manner. In a case where the connection device is implemented by using at least two information processing devices, the devices may be connected to communicate with each other via the communication interface 91.

The input/output interface 92 is a man-machine interface such as a keyboard as an example of an input device or a display as an output device.

The computing device 93 is implemented by a general-purpose central processing unit (CPU), an arithmetic processing device such as a microprocessor, or a plurality of electric circuits. For example, the computing device 93 can read various programs stored in the nonvolatile storage device 95 into the storage device 94 and execute processing according to the read program.

The storage device 94 is a memory device such as a random access memory (RAM) that can be referred to from the computing device 93, and stores programs, various data, and the like. The storage device 94 may be a volatile memory device.

The nonvolatile storage device 95 is a nonvolatile storage device such as a read only memory (ROM) or a flash memory, and can store various programs, data, and the like.

The drive device 96 is, for example, a device that processes reading and writing of data on a recording medium 97 described later.

The recording medium 97 can be any recording medium capable of recording data, for example, an optical disk, a magneto-optical disk, a semiconductor flash memory, or the like.

Each example embodiment of the present invention may be implemented, for example, by configuring a connection device by the information processing device 90 illustrated in FIG. 7 and supplying a program capable of implementing the functions described in each example embodiment to the connection device.

In this case, the example embodiment can be implemented by the computing device 93 executing the program supplied to the connection device. Not all but some of the functions of the connection device can be configured by the information processing device 90.

Furthermore, the program may be recorded in the recording medium 97, and the program may be appropriately stored in the nonvolatile storage device 95 at the shipment stage, the operation stage, or the like of the connection device. In this case, as a method of supplying the program, a method may be employed in which the program is installed in the connection device using an appropriate jig in a manufacturing stage before shipment, an operation stage, or the like. As a method of supplying the program, a general procedure such as a method of downloading the program from the outside via a communication line such as the Internet may be employed.

Some or all of the above example embodiments may be described as the following Supplementary Notes, but are not limited to the following.

### Supplementary Note 1

A connection device for connecting a host device and a target device that is a device to be connected to the host device, the connection device comprising:
reading means for reading device information, which is information capable of identifying a device, from the target device; and
connecting means for connecting the target device and the host device in a case where the device information read from the target device exists in an allowed list that is a list of the device information of a device connectable to the host device.

### Supplementary Note 2

The connection device according to Supplementary Note 1, further comprising:
acquisition means for acquiring the allowed list from a management server including the allowed list.

### Supplementary Note 3

The connection device according to Supplementary Note 2, wherein
the acquisition means transmits a certificate, which is information indicating that the connection device is a genuine product, to the management server, and
the allowed list is transmitted from the management server to the connection device in a case where the management server confirms that the connection device is a genuine product based on the certificate.

### Supplementary Note 4

The connection device according to any one of Supplementary Notes 1 to 3, further comprising:
storage means for storing connection device information that is information capable of identifying the connection device, wherein
a certificate that indicates that the connection device is a genuine product includes the connection device information, and
the connecting means performs connection between the target device and the host device in a case where the connection device information included in the certificate matches the connection device information stored in the storage means.

### Supplementary Note 5

The connection device according to any one of Supplementary Notes 1 to 4, further comprising:
detection means for storing cover information, which is information regarding opening and closing of a cover, in a cover information storage means based on a signal from a cover sensor for detecting opening and closing of the cover of a housing for accommodating the connection device, wherein
the target device is installed inside the housing, and
the connecting means performs connection between the target device and the host device in a case where the cover information stored in the cover information storage means indicates that the cover is not opened.

### Supplementary Note 6

A connection method of a connection device for connecting a host device and a target device that is a device to be connected to the host device, the connection method comprising:
reading device information, which is information capable of identifying a device, from the target device; and
connecting the target device and the host device in a case where the device information read from the target device exists in an allowed list that is a list of the device information of a device connectable to the host device.

### Supplementary Note 7

The connection method according to Supplementary Note 6, further comprising:
acquiring the allowed list from a management server including the allowed list.

### Supplementary Note 8

The connection method according to Supplementary Note 7, further comprising:
transmitting a certificate, which is information indicating that the connection device is a genuine product, to the management server, wherein
the allowed list is transmitted from the management server to the connection device in a case where the management server confirms that the connection device is a genuine product based on the certificate.

### Supplementary Note 9

The connection method according to any one of Supplementary Notes 6 to 8, wherein
connection device information that is information capable of identifying the connection device is stored in the connection device,
a certificate that is information indicating that the connection device is a genuine product includes the connection device information, and
connection between the target device and the host device is performed in a case where the connection device information included in the certificate matches the connection device information stored in the connection device.

### Supplementary Note 10

The connection method according to any one of Supplementary Notes 6 to 9, further comprising:
storing cover information, which is information regarding opening and closing of a cover, in a cover information storage unit based on a signal from a cover sensor for detecting opening and closing of the cover of a housing for accommodating the connection device, wherein
the target device is installed inside the housing, and
connection between the target device and the host device is performed in a case where the cover information stored in the cover information storage unit indicates that the cover is not opened.

### Supplementary Note 11

A computer-readable recording medium recording a connection program for a connection device that connects a host device and a target device that is a device to be connected to the host device, the connection program causing a computer to execute:
a reading function of reading device information, which is information capable of identifying a device, from the target device; and
a connection function of connecting the target device and the host device in a case where the device information read from the target device exists in an allowed list that is a list of the device information of a device connectable to the host device.

### Supplementary Note 12

The computer-readable recording medium recording the connection program according to Supplementary Note 11, the connection program further causing a computer to execute:
an acquisition function of acquiring the allowed list from a management server including the allowed list.

### Supplementary Note 13

The computer-readable recording medium recording the connection program according to Supplementary Note 12, wherein
in the acquisition function, a certificate, which is information indicating that the connection device is a genuine product, is transmitted to the management server, and
the allowed list is transmitted from the management server to the connection device in a case where the management server confirms that the connection device is a genuine product based on the certificate.

### Supplementary Note 14

The computer-readable recording medium recording the connection program according to any one of Supplementary Notes 11 to 13, wherein
the connection device includes a storage unit for storing connection device information that is information for identifying the connection device,
a certificate indicates that the connection device is a genuine product includes the connection device information, and
in the connection function, connection between the target device and the host device is performed when the connection device information included in the certificate matches the connection device information stored in the storage unit.

### Supplementary Note 15

The computer-readable recording medium recording the connection program according to any one of Supplementary Notes 11 to 14, the connection program further causing a computer to execute:
a detection function of storing cover information, which is information regarding opening and closing of a cover, in a cover information storage unit based on a signal from a cover sensor for detecting opening and closing of the cover of a housing for accommodating the connection device, wherein
the target device is installed inside the housing, and
in the connection function, connection between the target device and the host device is performed in a case where the cover information stored in the cover information storage unit indicates that the cover is not opened.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2021-193710, filed on Nov. 30, 2021, the disclosure of which is incorporated herein in its entirety by reference.

### REFERENCE SIGNS LIST

10, 20 connection device
11, 21 reading unit
12, 22 connecting unit
23 acquisition unit
24 storage unit
25 determination unit
26 detection unit
27 cover sensor
28 cover information storage unit
40 target device
50 host device
60 management server
80 communication line
90 information processing device
91 communication interface
92 input/output interface
93 computing device
94 storage device
95 nonvolatile storage device
96 drive device
97 recording medium

What is claimed is:

1. A connection device for connecting a host device and a target device that is a device to be connected to the host device, the connection device comprising one or more memories storing instructions and one or more processors configured to execute the instructions to:
read device information, which is information capable of identifying a device, from the target device; and
connect the target device and the host device in a case where the device information read from the target device exists in an allowed list that is a list of the device information of a device connectable to the host device.

2. The connection device to claim 1, wherein the one or more processors are configured to execute the instructions to:
acquire the allowed list from a management server including the allowed list.

3. The connection device to claim 2, wherein
the one or more processors are configured to execute the instructions to transmit a certificate, which is information indicating that the connection device is a genuine product, to the management server, and
the allowed list is transmitted from the management server to the connection device in a case where the management server confirms that the connection device is a genuine product based on the certificate.

4. The connection device to claim 1, wherein
connection device information that is information capable of identifying the connection device is stored in the connection device,
a certificate that is information indicating that the connection device is a genuine product includes the connection device information, and
connection between the target device and the host device is performed in a case where the connection device information included in the certificate matches the connection device information stored in the connection device.

5. The connection device to claim 1, wherein
the one or more processors are configured to execute the instructions to store cover information, which is information regarding opening and closing of a cover, in a cover information storage means based on a signal from a cover sensor for detecting opening and closing of the cover of a housing for accommodating the connection device,
the target device is installed inside the housing, and
connection between the target device and the host device is performed in a case where the cover information stored in the cover information storage means indicates that the cover is not opened.

6. A connection method of a connection device for connecting a host device and a target device that is a device to be connected to the host device, the connection method comprising:
reading device information, which is information capable of identifying a device, from the target device; and
connecting the target device and the host device in a case where the device information read from the target device exists in an allowed list that is a list of the device information of a device connectable to the host device.

7. The connection method to claim 6, further comprising:
acquiring the allowed list from a management server including the allowed list.

8. The connection method to claim 7, further comprising:
transmitting a certificate, which is information indicating that the connection device is a genuine product, to the management server, wherein
the allowed list is transmitted from the management server to the connection device in a case where the management server confirms that the connection device is a genuine product based on the certificate.

9. The connection method to claim 6, wherein
connection device information that is information capable of identifying the connection device is stored in the connection device,
a certificate that is information indicating that the connection device is a genuine product includes the connection device information, and
connection between the target device and the host device is performed in a case where the connection device information included in the certificate matches the connection device information stored in the connection device.

10. The connection method to claim 6, further comprising:
storing cover information, which is information regarding opening and closing of a cover, in a cover information storage unit based on a signal from a cover sensor for detecting opening and closing of the cover of a housing for accommodating the connection device, wherein
the target device is installed inside the housing, and
connection between the target device and the host device is performed in a case where the cover information stored in the cover information storage unit indicates that the cover is not opened.

11. A non-transitory computer-readable recording medium recording a connection program for a connection device that connects a host device and a target device that is a device to be connected to the host device, the connection program causing a computer to execute:
a reading function of reading device information, which is information capable of identifying a device, from the target device; and
a connection function of connecting the target device and the host device in a case where the device information read from the target device exists in an allowed list that is a list of the device information of a device connectable to the host device.

12. The non-transitory computer-readable recording medium recording the connection program to claim 11, the connection program further causing a computer to execute:
an acquisition function of acquiring the allowed list from a management server including the allowed list.

13. The non-transitory computer-readable recording medium recording the connection program to claim 12, wherein
in the acquisition function, a certificate, which is information indicating that the connection device is a genuine product, is transmitted to the management server, and
the allowed list is transmitted from the management server to the connection device in a case where the management server confirms that the connection device is a genuine product based on the certificate.

14. The non-transitory computer-readable recording medium recording the connection program to claim 11, wherein
the connection device includes a storage unit for storing connection device information that is information for identifying the connection device,
a certificate indicates that the connection device is a genuine product includes the connection device information, and
in the connection function, connection between the target device and the host device is performed when the connection device information included in the certificate matches the connection device information stored in the storage unit.

15. The non-transitory computer-readable recording medium recording the connection program according to claim 11, the connection program further causing a computer to execute:
a detection function of storing cover information, which is information regarding opening and closing of a cover, in a cover information storage unit based on a signal from a cover sensor for detecting opening and closing of the cover of a housing for accommodating the connection device, wherein
the target device is installed inside the housing, and
in the connection function, connection between the target device and the host device is performed in a case where the cover information stored in the cover information storage unit indicates that the cover is not opened.
